(19) United States
(12) Patent Application Publication
(10) Pub. No.: US 2009/0077071 A1
(43) Pub. Date: Mar. 19, 2009

(54) SYSTEM AND METHOD FOR RESPONDING TO A SEARCH REQUEST

(75) Inventors: Shahla MISHKANIAN, Woodland Hills, CA (US); Nathan Khoshnood, Woodland Hills, CA (US); Daniel Kay, Woodland Hills, CA (US)

Correspondence Address: MORRISON & FOERSTER, LLP, 555 WEST FIFTH STREET, SUITE 3500, LOS ANGELES, CA, 90013-1024, US

(73) Assignee: Mainstream Advertising , Inc., woodland Hills, CA (US)

(21) Appl. No.: 12/269,870

(22) Filed: Nov. 12, 2008

Related U.S. Application Data
(63) Continuation of application No. 11/441,701, filed on May 26, 2006.
(60) Provisional application No. 60/793,190, filed on Apr. 18, 2006.

(51) Int. Cl. G06F 17/30

(52) U.S. Cl. 707/5; 707/3; 707/E17.015; 707/E17.108

(57) ABSTRACT

Provided is a system and method for context based searching. A participating website may be provided with an interface which allows users to perform searches by indicating keywords to be searched. A search services provider performs a search based on the keywords as well as the context of the participating website. In a further development, the context of the participating website may be determined by deriving one or more context words from the text of the participating website. In a second aspect, a system and method are provided which allow a user to move results in a list of results provided in response to search request. These actions of the user are recorded and saved. The rankings of subsequent searches are based on these recorded actions.

### CROSS REFERENCE TO RELATED APPLICATIONS

This application is a continuation of U.S. patent application Ser. No. 11/441,701 filed May 26, 2006, which in turn claims priority pursuant to 35 U.S.C. § 119(e) to U.S. Provisional Application No. 60/793,190, filed Apr. 18, 2006, which applications are specifically incorporated herein, in their entirety, by reference.

### BACKGROUND

1. Field of the Invention

This invention is in the general field of data technology and in the more specific field of search engines.

2. Background of the Invention

Large computer networks, most notably the Internet, as well as improvements in computer storage have revolutionized the way we access information. However, the undeniable advantages of having immediate access to large amounts of information poses some new challenges. One specific problem is how one can find needed information in the vast array of data of a large network or a computer storage system. The relatively unstructured and disorganized nature of the Internet exasperates this problem.

Initially, various search engines were designed to allow users to find relevant websites on the Internet. The first generation of search engines included, for example, Web Crawler, Alta Vista, and Hotbot. These engines accessed publicly available lists of registered domain names and retrieved each page associated with such domain name. They scanned the full text of that page and enter into a database information about the words included on that webpage. The information stored depended on the particular search engine but usually included the most commonly appearing word on the webpage and a number of times each word appears. Thus, each word received a “score” indicating how often it appeared on a page. Sometimes additional rules were present, such as not counting commonly appearing words that are usually not very informative (such as “the”, “a”, “in”, etc.), counting similar words as the same word, etc. This process is usually referred to as scanning or indexing. The search engine then identified all the hyperlinks in a webpage and followed them in order to retrieve other pages. These newly retrieved webpages are indexed as well. The process of automatically following links on webpages and indexing all retrieved webpages is commonly referred to as crawling.

Having had indexed a large number of pages, a search engine may offer to perform searches for a user. Typically, a user is requested to enter key words in a field at a search engine's homepage. The search engine then searches its database for webpages which feature high scores of these key words. Certain search engines used other more complex features such as allowing for the search for phrases, allowing for search strings using Boolean logic, performing some natural language processing, etc.

Most webpages are written in Hypertext Markup Language, or HTML. This language allows a webpage creator to assist the search and categorization of his/her webpage by specifying certain information about the webpage within the HTML definition of the webpage. Thus, for example a title of the webpage may be specified. Metadata about the webpage may be included. The metadata are words that describe the subject of the webpage but are not displayed on the visual representation of the webpage. Nevertheless, the metadata is part of the code of the webpage and may be accessed and used by search engines or other automatic tools for categorization of webpages. The title and metadata fields are usually analyzed and used by search engines. For example, words appearing in the title and metadata fields may be added to the database, but given higher scores.

The rapid expansion of the Internet caused search engines to provide large numbers of results for many searches. Thus, the order, or ranking in which results were presented to the user, became important. A user will usually scan the presented results in the order in which they were presented. When a search returned a large number of results, a user would usually only pay attention to the results that appeared first. This phenomenon is important both for search engines and websites. If a search engine is to succeed in its main purpose of providing a user with relevant information, it must rank the most relevant websites higher; otherwise the user would not notice them. On the other hand, if a website owner desires that his/her website is visited by a large number of users, he/she must ensure that the website is ranked high on various search engines' results for popular searches.

Most first generation search engines ranked results based on how well the search terms matched the stored indexed information of each resulting webpage. For example, if the search terms had a high score in the indexed data for a particular webpage, the results would have been ranked higher.

The first generation search engines were reasonably effective until the expansion and commercialization of the Internet introduced the disruptive idea that pecuniary gains may be obtained by having large amounts of users visiting one's website, even if these users were not interested in the website and did not consider it relevant for the information they were seeking. Thus, some website owners started configuring their websites in order to intentionally mislead search engines into determining that the websites were relevant for certain popular queries. For example, websites may be designed so that they included high numbers of commonly queried words without providing any relevant information about these words. Commonly queried words may also be included in the metadata and title fields of a webpage, even though the webpage does not include any useful information about these terms. Websites like these are often referred to as spam and the people that design them as spammers.

The use of the above discussed intentional deceptions were very damaging to the effectiveness of first generation search engines and the ability of users to find useful information on the Internet. Users were often directed to pornography or gambling websites when their search requests had nothing to do with these subjects. Thus, in order to find relevant information, users would often have to wade through dozens of unrelated and sometimes quite offensive websites.

Google, a search engine, uses indexing and scanning methods similar to the ones discussed above to determine if a site is relevant for a particular set of entered search terms. But ranking among the sites considered to be relevant is performed in a different manner. Google generally ranks each webpage by considering how many and which other websites include hyperlinks to that particular webpage. Thus, the Google search engine operates under the assumption that if a first webpage links to a second webpage, that is an acknowledgement that the second webpage includes useful information.

However, Google's search engine includes some considerable shortcomings. First, a new generation of hackers has developed sophisticated methods of deceiving Google's advanced search algorithms. These methods usually include large numbers of interlinking webpages specifically created to increase the ranking of a particular website.

Secondly, Google's central assumption that the number of incoming links a webpage or a website has is an indication of the relevance and usefulness of that website is showing its limits. Even if this assumption is to be taken at face value, it can be seen that it cannot apply to all situations. That is the case because a website may be relevant and informative on one subject and completely irrelevant and useless on another. Thus, a high number of incoming links may indicate the relevance and popularity of a website in subject A, but the website could include no useful information on subject B. Suppose, that by a coincidence the website includes some terms that may be otherwise used to describe subject B, and a user performs a search based on these terms in search of information on subject B. Then, the Google search engine may interpret the large number of incoming links the website has as an indication that the website is very relevant and informative about subject B, and incorrectly give the website a high ranking in the search results for subject B.

The ideal search engine would be such that a user would be able to interact with it the same way one would interact with another human being. Accordingly, the science of search engine design has often touched on the study of human interaction and speech. Specifically, human interaction is often very dependent on context. The same words may mean different things depending on the context they are used in. For example, the word “jaguar” may refer to a feline species, a brand of automobiles, or a console game system depending on which context it is used in. Even words that we usually consider to have a single definition can carry different nuances in meaning depending on the context they are used in.

The context of a situation is something a person is not usually consciously aware of. Thus, when a person uses a word, he/she does not consciously determine what the context of the situation in which the word is to be used is, what is the particular meaning of the word in this context, and whether this particular meaning is the actual meaning the person is trying to articulate. On the contrary, a person usually chooses expressions which have the intended meaning in the current context without explicitly considering the significance of the context.

This creates problems for most search engines. As discussed above, most search engines attempt to emulate human interaction and thus allow a user to submit queries in natural language. However, the meaning of a natural language query would depend on the context in which it is being made, and existing search engines possess no means to gauge such context. In practice, this often results in a user submitting a query and then being frustrated by receiving many results which are completely unrelated to the information the user sought even though they may include the exact words of the user's query. To continue the above presented example, a user that queries for a certain species of wild cat, is very likely to be confronted with a screen full of links to car dealerships in his or her first search attempt. The user must then think of the context in which he used the words and try to add additional search terms. This is not easy for most people, because as discussed above, the context of our communication is something we usually process subconsciously and therefore are not easily able to articulate. Naturally, the additional search terms are also likely to be subject to alternative interpretations. Thus, for most ordinary users, searching the Internet involves a long and frustrating process of attempting and refining multiple queries in order to properly articulate something that could have easily be described in a single phrase in a conversation with another person.

Considering the above, a search engine which can better interpret natural language queries is needed. Also, needed is a search engine which can better rank results based on their relevance.

### SUMMARY OF THE INVENTION

In a first aspect of a present invention a system and method for context based searching is provided. A participating website, vertical or other organized collection of information may be provided with an interface which allows users to perform searches by indicating keywords to be searched. A search service provider performs a search based on keywords as well as the context of the participating website.

In accordance with the preferred embodiment, the context of the participating website may be determined by deriving one or more context words from the text of the participating website. The search may be performed by combining the context words with the keywords indicated by the user, and performing a search based on the combined words.

In an alternative embodiment, a system and method are provided that allow a user to move results in a list of results provided in response to search request. These actions of the user are recorded and saved. The rankings of subsequent searches are based on these recorded actions. In a further development, the actions of various users are recorded with reference to the type of search that caused the results on which the users are acting on. The users' actions then influence the ranking of results of searches of the same type only. The type of search may refer, for example, to the keywords used for the search.

In a further development various users' acts of clicking on a link presented as a result of a search similarly influence the rankings of subsequently issued results.

In a third aspect of the present invention the first and second aspects discussed below are combined in a single system and method.

### BRIEF DESCRIPTION OF THE DRAWINGS

FIG. 1 is conceptual diagram of the Internet;

FIG. 2 is a an example of a webpage that includes a search box according to an embodiment of the present invention;

FIG. 3 is a general diagram of an exemplary configuration/environment of the present invention.

FIG. 4 is a flowchart showing the process of initializing a search box in accordance with an embodiment of the present invention;

FIG. 5 is a diagram of an example search results page;

FIG. 6 is a diagram of a memory structure utilized by the search services provider of an embodiment of the present invention; and

FIG. 7 is a flowchart showing how a search is performed according to a preferred embodiment of the present invention.

### DETAILED DESCRIPTION OF EXEMPLARY EMBODIMENTS

While search engines are most well known in the context of the Internet, their usefulness is not so limited. Search engines may be used in other large networks, such as internal corporate or organizational networks (i.e., Intranets). Furthermore, search engines may be used to search the contents of various databases or other storage elements, even the hard drives of personal computers. The description below is made in reference to the Internet. However, a person of skill in the art would readily recognize that the teachings below are applicable generally to search engines regardless of the medium being searched. Thus, references to webpage may refer to any other visualizable information unit.

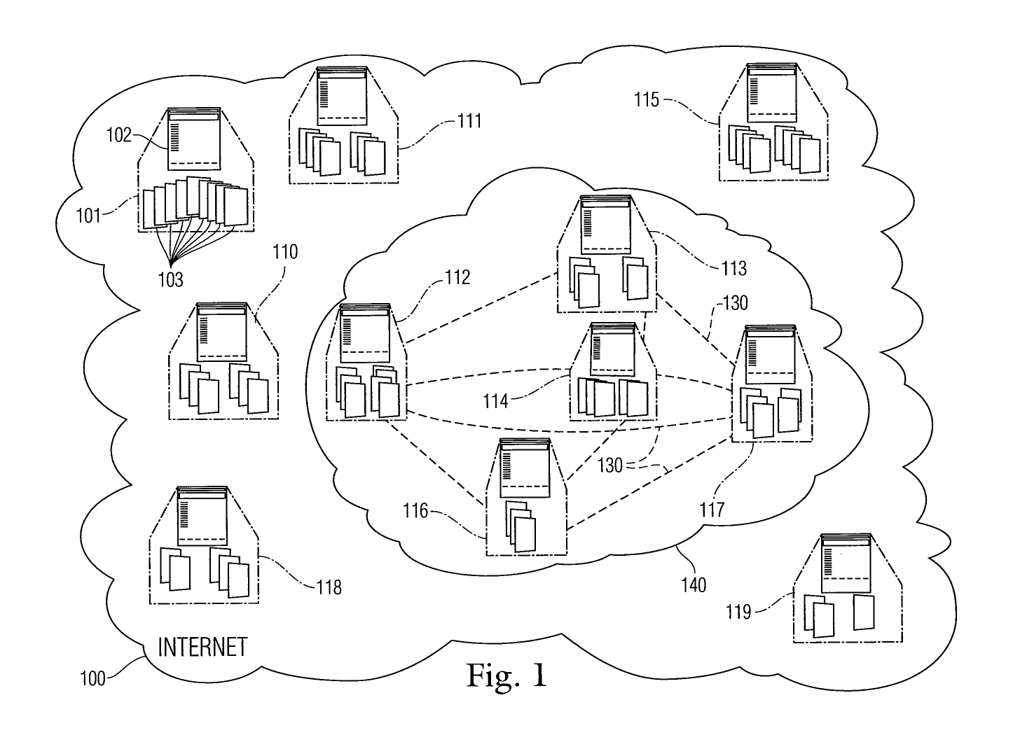

FIG. 1 is a conceptual diagram of the Internet 100. The Internet includes a multitude of websites such as website 101. Each website includes one or more webpages which may be static or dynamically generated. The pages of a website are differentiated between an index page, which is usually the first page a visitor to the website encounters and server as a “portal” to an entire website and one or more other pages that are usually accessible directly or indirectly through the index page. Thus, a typical website 101 includes an index page 102 and a plurality of other pages 103.

Some of the additional websites are depicted as websites 110-118. The broken lines 130 represent thematic similarities between the subject matter of various websites. Thus, for example, site 114 may be about cycling in general, while site 116 may be about the technical characteristics of various bicycles, site 112 may be about bicycle tires, site 117 may be about cycling trails, etc.

A plurality of websites that have such thematical similarities can be designated as a thematical set of websites 140. This set need not be explicitly defined or acknowledged but may exist merely because of the thematic similarities of the content of the different sites.

Currently, Internet search engines allow for the search of the entire Internet 100 or for the search of a single website, such as website 101. However, presently existing search engines do not allow for the search of a thematic set of websites 140. This is one of the several advantages presented by the various embodiments of the present invention.

To consider these and other advantages from another perspective one must visit the issue of context discussed above. As discussed above, existing search engines' inability to take context into account results in the failure of these search engines to provide users with natural means of interaction.

Embodiments of the present invention allow for recognizing and using context without requiring a user to explicitly state it. It is recognized that, if a user is reading a website that includes content on a specific subject, the user is probably thinking about that subject. Consequently, if a user wishes to find additional information while examining the website, the additional information sought would probably be related to the subject matter of the website. Embodiments of the present invention contemplate placing a search interface at that website and allowing the user to request searches from that interface. The website from which a search request is received is noted, and the results of that request are targeted not only to the query terms the user specifically designated, but also preferably to the general context of the website.

In the art, a website, one or more webpages, or another user accessible collection of content which is presented as a coherent package is commonly referred to as a “vertical.” Thus, a vertical may be a single website or a collection of webpages that are part of a larger website. Some larger websites, such as, for example, MySpace.com and Friendster.com, allow users to create and organize webpages therein, thus in a way creating websites within other websites. Thus, a set of webpage within a larger website, such as MySpace.com that are created and controlled by a user may be referred to as a vertical.

Embodiments of the present invention allow for an owner or administrator of a website or another vertical to add a search box to his/her vertical in order to allow visitors thereof to take advantage of the advanced search features of the present invention. In certain embodiments the owner may be monetarily or otherwise compensated for placing the search box (alternatively, the owner may be merely motivated by the desire to improve the browsing experience for the visitors of his/her vertical).

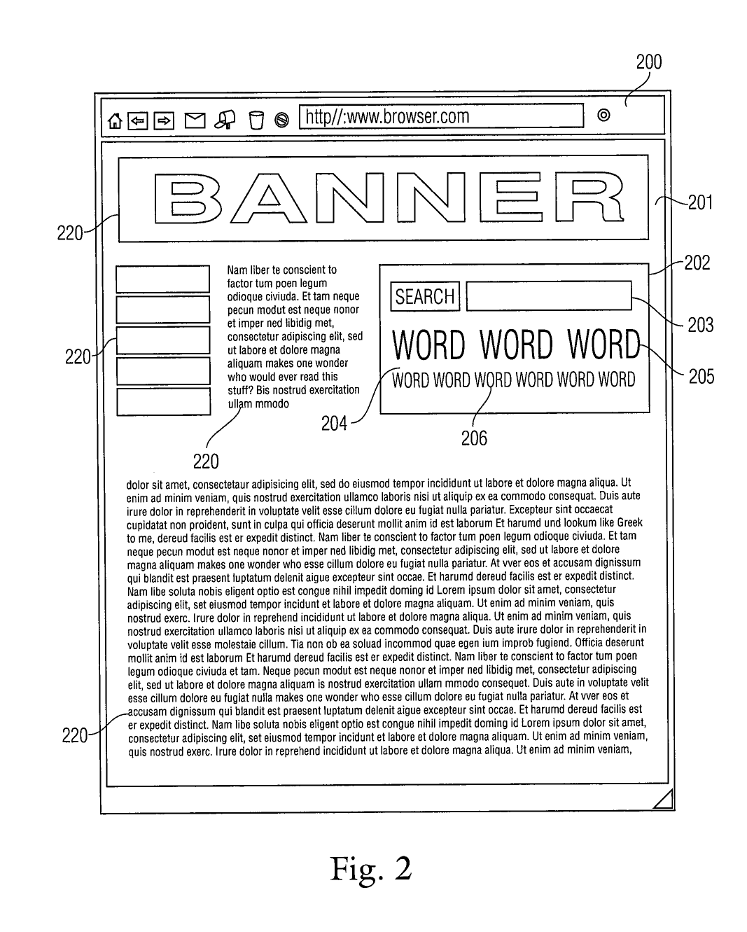

FIG. 2 is a diagram of a website which includes an example of a search box in accordance with an embodiment of the present invention. A browser 200 is shown displaying a webpage 201. The webpage may include various textual or graphic elements 220 that are part of the preexisting webpage content. The webpage also includes a search box 202. The search box preferably includes a field 203 where a user may enter search terms and various predefined suggested search terms 204. The suggested search terms may be grouped into two or more groups of varying significance, the significance being indicated by visual cues. In the example shown by FIG. 2, the search terms are grouped into a first group 205 and a second group 206. The higher significance of group 205 is indicated by the larger font.

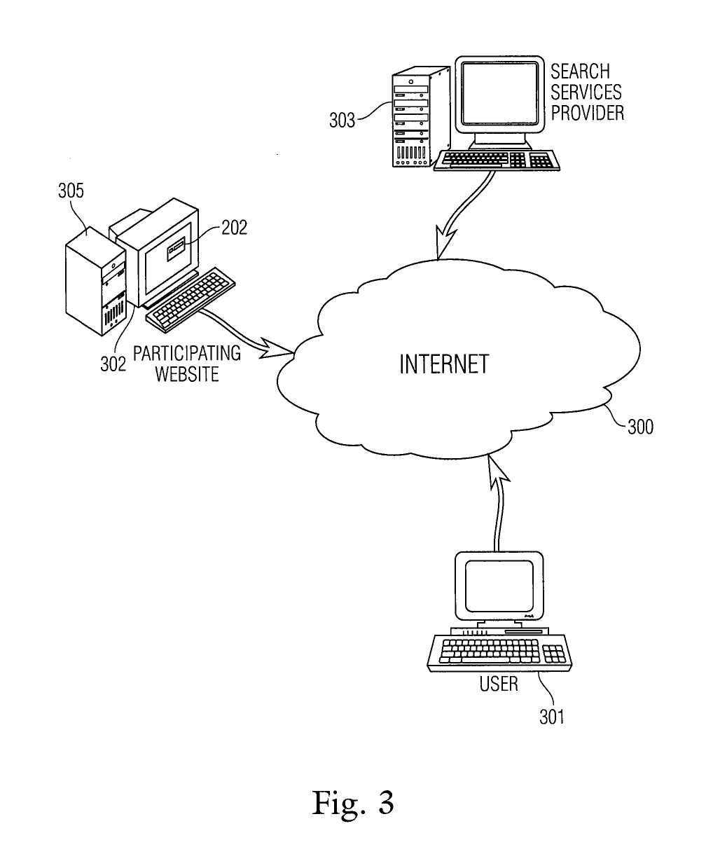

FIG. 3 is a general diagram of the preferred configuration/environment in which the present invention may be utilized. In the preferred embodiment, the administrator of a participating website 302 hosted at a server 305 decides to take advantage of the present invention and adds a search box 202 (as shown in FIG. 2) to the participating website. The process of adding a search box is described in more detail below. A user 301 accesses the website 302 through the Internet 300. The user may wish to perform a search by entering text in the search box to initiate the search.

Preferably, a search services provider 303 provides and organizes the functionality of the present invention. If the user initiates a search, the search request is forwarded to the search services provider, and the search services provider sends a webpage to the user listing the results of the search. The user may then choose a search result by clicking on a link associated with the result or may perform additional actions, such as re-ranking the results, as discussed below.

It should be noted that the present invention may also be utilized in alternative configurations/environments. For example, in accordance with an alternative embodiment, the participating website 302 may be hosted at the same server as the search services provider 303.

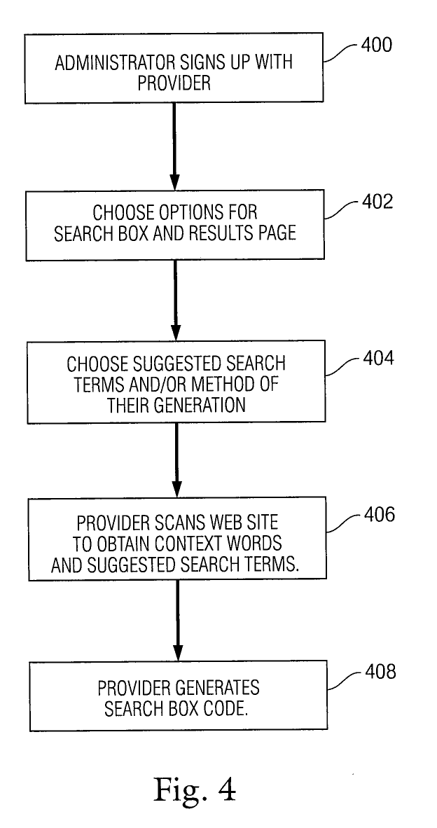

FIG. 4 is a flow chart showing the process by which an administrator of a website may add a search box in accordance with a preferred embodiment of the present invention. Specifically, FIG. 4 shows the process by which an ordinary website may become participating website 302. The term “admin.” refers to the administrator of the website which is to become a participating website or is otherwise in control of that website, and the term “provider” refers to the search service provider 303, or in other words a machine that provides search services according to embodiments of the present invention.

At step 400, the administrator signs up with the search services provider. At the sign up step the administrator identifies the website and/or vertical which is being enrolled. This identification is usually accomplished by providing a URL of the website/vertical. At step 402 the administrator chooses various options. Some examples of available options may include colors of the search box, shape and presentation of the search box, colors and presentation of the results page which a user will see if he/she performs a search, title of the search box/results page etc.

The administrator may also choose various blocking options at step 402. Once the initialization process of FIG. 4 is completed, various end users will be able to perform searches at the administrator's website. Thus, the end users would most likely associate the results of the searches with the participating website where they performed the searches. For that reason, the administrator may have an incentive to control the search results.

In the preferred embodiment, the administrator may control the search results by blocking keywords or webpages. A blocked keyword will not be used in a search even if it is entered by the user. A blocked webpage will not be displayed as part of the search results, even if it matches search terms entered by the user. In step 402, the administrator enters the key words and/or webpages he/she wishes to be blocked.

At step 404, the user chooses the suggested search terms and/or the method in which they are generated. Suggested search terms may be generated in three different ways: (i) by being entered by the administrator, (ii) by examining the website/vertical and choosing some terms which are commonly used within the website as suggested search terms, and (iii) by tracking usage of that particular search box and choosing terms that are most commonly searched for as suggested search terms. In the preferred embodiment the administrator chooses the number of suggested search terms, the relative significance of each suggested search term which controls how the suggested search term is displayed (see discussion of FIG. 2), and the method by which each suggested search term is to be generated. If any suggested search terms are to be entered by the administrator, the administrator must also specify those suggested search terms.

At step 406, the provider scans the administrator's web site. The scanning is performed to define one or more context words which define the context of the website/vertical and in the event that any of the suggested search terms were to be determined by examining the website/vertical (according to the administrator's settings as specified in step 404), to define those search terms.

The context words of a website or a vertical are terms which best describe the general theme or topic of the website. Thus, for example, a website about golfing would preferably have “golf” as its context word. The context words may be one or two or a phrase, but usually a small number of context words is preferable. The context words are used to limit a user's search to the context of the website from which he/she is searching.

The context words are preferably defined by scanning a website in a manner similar to the one ordinary search engines use to index websites. In accordance with one embodiment, the words used in a website are identified and counted and the most commonly used words or phrases (after non-informative words such as, e.g. “a” “the” and “in” have been removed) are noted. In certain embodiments, the title, and metadata fields of the website are also scanned and their words may be given higher or lower score as compared to words of the body of the website. While most conventional search engines scan the various webpages individually, it is preferable that in step 406 the website or vertical is scanned as a whole. Thus, if the website or vertical include multiple pages, all pages are scanned and their scores are combined.

The scan produces a ranking of the words of a website or vertical according to how often they are used. The single most commonly used word or phrase is preferably designated as a context word. In some embodiments, additional words may also designated as context words, depending on the distribution of scores. For example, if two words are very commonly used (i.e. have high scores) and there are no additional words with similar scores, both words may be designated as context words. After the context words are designated, depending on the configurations of step 404, the necessary number of words with the next highest scores are designated as suggested search terms.

A similar scan may be performed periodically after this initialization process is completed in order to capture any changes that may have been made to the participating website or vertical 302.

At step 408, the provider generates a search box code. The search box code is intended to be placed within the code of one or more of the webpages of the participating website and when placed therein to cause a browser to display a search box as defined in the previous steps. Furthermore, the code is operative to create a field, into which a user may enter search terms, and a button which the user may press to initiate a search. Search is initiated by having the search box code send a request which includes the search terms entered by the user to the search services provider. Furthermore, the search box code should display the suggested search terms 204 as clickable links, and when a user clicks on a suggested search term, send a search request to the provider including the clicked on search term. The search box code may also include but not display the context word(s). In this case, the context words are not displayed but they are sent as part of the search request to the search services provider. Alternatively, the context words may be saved at the search services provider. Preferably, the search box code is automatically generated by the search services provider.

Persons of skill in the art would recognize that there are various ways in which the search box code may be generated in order to fulfill the above functions. Currently, webpages are defined by a mark-up language (usually Hypertext Markup Language, or HTML). A set of mark up language terms may define the presentation of an entire webpage to a web-browser. In other words, the mark up language may define how and where various text, graphics, symbols, etc. are to be placed within a webpage.

Furthermore, webpages may include applets. Applets are pieces of executable computer code which are provided as part of webpages and are executed to create some or all of the content of a webpage. Applets are usually written in languages such as Java, Javascript, Active-X, AJAX, etc. Applets may be executed at the user's browser or at a server. A person of skill in the art would recognize that the search box code may be automatically generated markup language code, or an automatically generated applet or a combination of the above.

Furthermore, the search box code may be local or remote. Local code indicates code that is generated once at step 408 and is saved as part of the participating website 302 by the web server 305 (see FIG. 3). When the user 301's browser accesses the participating website it retrieves the search box code from the server 305 and the user's browser displays the search box according to the search box code. If remote code is used, the participating website does not retain code sufficient to display the search box, but a short piece of redirecting code which includes a reference to the search services provider 303 as well as additional identification information. When the user accesses the participating website 302, the redirecting code causes the user's browser to access the search services provider and to send the additional identification information to it. The search services provider examines the identification information and based on it, it sends suitable search box code to the user's browser. The search box code then causes the user's browser to display the search box according to the configurations performed in the previous steps.

The remote method of providing the search box code may have some advantages. For example the search box code may be changed by the search services provider in order to improve functionality and appearance and/or resolve errors without necessitating changes of the participating websites. Both local and remote search box codes may include HTML and/or applets. Furthermore, both local and remote search box codes may be statically or dynamically created.

An example of statically created HTML local search box code is provided below as Appendix A.

The search box code is described herein in the context of the World Wide Web. However, persons of skill in the art will understand that similar search box codes that execute the above discussed functions may be provided in other ways in the context of alternative systems for disseminating information which are currently known or may be available in the future, or alternative languages for the World Wide Web which are currently known or may be available in the future.

After the search box initialization process the participating website 302 or vertical may offer advanced search services according to embodiments of the present invention. Thus, a user may access the participating website and use it to perform a context based search. The user may enter text in the search box of the participating website, or alternatively click on one of the suggested search words. The search services provider will receive the entered search term (or clicked on suggested search term) and perform a search based on it as well as the one or more predefined context words. More details on how this search is performed and how the results are ranked are provided below.

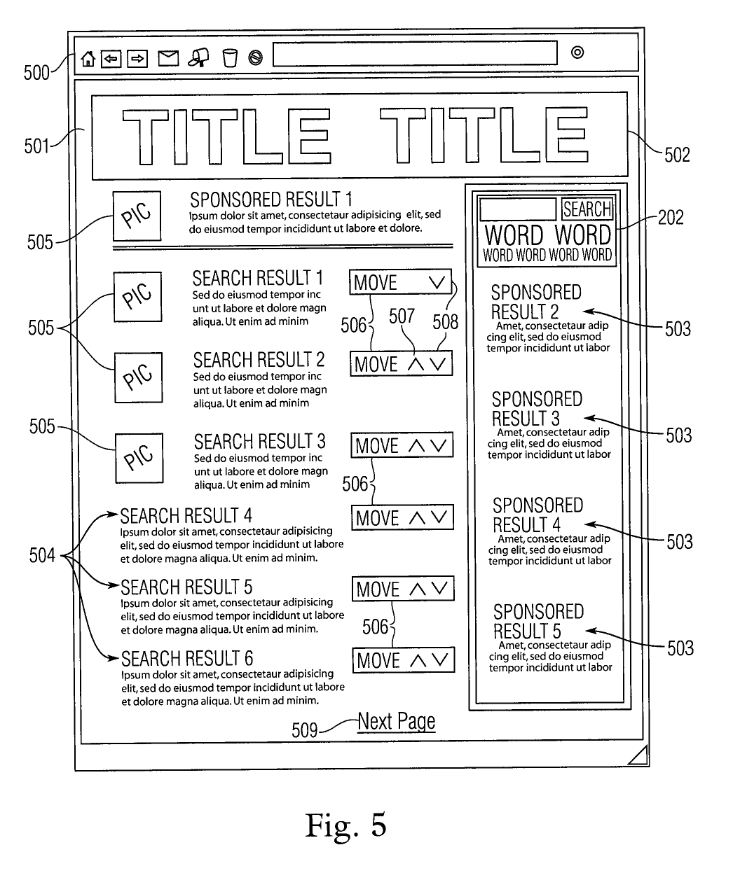

Once the search is performed and the results are ranked, the search services provider may create and send to the user a search results page. FIG. 5 is a diagram of an example search results page. A browser 500 displays a search results webpage 501.

While search results webpage 501 is preferably created and served by the search services provider 303 it is also preferable that it retain certain visual elements which would make it similar to the participating website or vertical 302 where the search was originated. Thus, the user may be given the impression that the search results webpage 501 is actually part of the participating website or vertical 302. This would make things simpler for the user (changing websites often tends to confuse users) and would also often make the owner or administrator of the participating website or vertical more comfortable, as website owners usually prefer to keep users within the confines of their websites for as long as possible.

This similarity may be achieved by having the administrator of the participating website or vertical choose the appropriate options at step 402 of the search box initialization process. As discussed above, at that point the administrator chooses the colors and other presentation options of the results page. The administrator may be encouraged to choose colors, graphics and other presentation options which match those of his website of vertical.

Furthermore similarity is achieved by the title text 502 of the results page 501. It is preferable that the title text is copied from the title of the participating webpage or vertical, and the title text area is a clickable link to the participating website or vertical 302 where the search request originated.

The results page also preferably includes a search box 202 which is similar if not identical to the search box 202 of the original participating webpage or vertical. The existence of a search box at the results page allows a user to quickly and easily perform additional searches if the current search did not yield satisfactory results.

The results page preferably includes a plurality of sponsored results 503. The sponsored results are links for whose display a third entity has paid for (or provided other consideration). The sponsored results links are preferably chosen among many sponsored links by performing a search based on the search terms entered by the user in combination with the context terms. Thus, the sponsored results are usually relevant to the user's current search as well as the context of the website or vertical where the search was originated.

Currently, there exist services which offer advertising opportunities to their clients and provide sponsored links which third parties can display in exchange of payment (sometimes payment is based on the number of times a link is displayed and sometimes on the number of times a link is actually clicked on). One such existing service is Adwords, offered by Google. In a preferred embodiment, when the search services provider receives a query, it sends the query words and the context words to Adwords and requests sponsored links based on these words. Adwords responds by sending plurality of sponsored results 503. The search services provider then formats and encloses these sponsored results in the results page.

The results page may also include a plurality of non-sponsored search results, or simply search results 504. These are placed at a prominent position on the search page. Each search result includes a link to a webpage as well as a short description of the webpage being linked to. The short description is usually obtained by automatically copying text from the webpage which is close to the searched for and context words. The specific method of obtaining and ranking the non-sponsored search results is discussed in more detail below.

Preferably, several of the higher ranked sponsored and non-sponsored search results include small pictures or thumbnails 505. It can be seen that on the results page shown on FIG. 5 one sponsored and three non-sponsored search results include pictures. The number of results which include pictures may vary; it is an implementation detail which depends mostly on the desired visual structure of the results page.

The pictures may be obtained automatically by the search services provider by scanning the results webpages for images displayed prominently thereon, and automatically retrieving, resizing and incorporating these images in the results page. Alternatively or in addition, webpage administrators who wish to have further control over how links to their webpages appear on the results page, may be allowed to register with the search services provider and store or reference therein a picture which may be used when displaying a link to that webpage. A short description of the webpage may also be stored. When the search services provider receives a group of results, it checks its database whether any of the results have been registered and if so it uses previously stored pictures or descriptions when displaying these results.

Each search result 504 is preferably associated with a separate move button 506. The move button allows a user to contribute to the ranking of the results based on his/her own opinions as to the relative relevance of the different results. Each move button may include an “up” 507 and a “down” 508 button (the top search result is an exception—it usually only includes a down button). The user may use the “up” and “down” buttons 507, 508 in order to promote or demote results in the ranking according to his/her opinion of a particular result's relevance to the user's query. A click on the “up” button naturally causes a result to ascend in the ranking, while a click on the “down” button causes a result to descend in the ranking. The top result cannot ascend in the rankings any more, thus it usually lacks an “up” button.

The user's use of the “up” and “down” buttons affects more than the rankings of the search result page 501 the user is currently viewing and manipulating. It preferably affects the rankings in all search results pages which are created and displayed in response to the same query from the same participating website as the present search results page. That is the case even if those other search result pages are displayed for other users. After some continued operation, the users will have generated significant amount of input, and ranking of the results of new searches will be based in large part on user input. Therefore, this human input based ranking of the results will be more helpful to users than the rankings generated by currently available search engines which are entirely based on machine analysis.

In an alternative embodiment, the sponsored results may also be associated with move buttons and benefit from human input rankings. This is not the case for the currently preferred embodiment, because most currently existing brokers of sponsored links (such as, e.g., Adwords) require that sponsored links are displayed in a particular order, as they charge the sponsors of the links according to the expected ranking of each link. However a person of skill in the art would recognize that changes to the business model of providing sponsored links may allow the move buttons to be used for the sponsored links.

In an alternative embodiment, only an “up” arrow may be present in the sponsored links. This would simplify the interface of the search results page, while still allowing users to provide their input on the ranking of results.

Further developments of the present system may include additional safeguards against improper exploitation of the system. For example an identifier (such as an IP address) may be obtained from users which click on the move buttons. Users with a specific identifier may be allowed to modify the rankings only a limited number of times. Alternatively some users may be allowed to sign in and only signed in users may be allowed to affect the rankings of websites. Statistical analysis may be used to check whether signed in users are abusing the system by over-promoting unrelated websites.

In addition to above discussed move button rankings, “clicks” may also be used to rank search results. A click is the action of a user clicking on a link provided as a part of a search result. In an embodiment of the present invention, when the search services provider creates the search results webpage it does not place a direct link to the referenced webpage in each search result 504 or sponsored result 503. Instead a link to the search services provider is placed. Thus, when a user clicks on a search result 504 or a sponsored result 503, the user's browser is first directed to the search services provider. After that the search services provider immediately redirects the user's browser to the website which was referenced by the clicked search or sponsored result. Usually the redirection is sufficiently fast so that the user does not recognize that he/she has been redirected. However, because the redirection does occur, the search services provider may gather information on which links users click on and may rank the search results based on the number of times users click on them. Similar to the move button rankings discussed above, click rankings are also specific to specific search terms and participating websites. Thus, a high click rate for searches performed at a first participating site for a first set of search terms will not help the ranking of a search result when it appears after a search at a second participating website for a second set of search terms. Sponsored results may also be ranked by clicks; however, the possible limitations on ranking sponsored results discussed above in the context of move button ranking also apply.

Move button and click rankings may be combined. For example each click and each move button promotion may be designated a certain amount of points (move button demotions would be designated negative points). The ranking of each search result would depend on the aggregate of points that result has obtained. Preferably move button use (moving) should result in higher number of points than clicking, as moving signifies an intent to give a certain search result a higher or lower ranking, while clicking may be done merely to investigate a search result without having reached a conclusion that that result is necessarily relevant.

A next page link 509 allows the user to move to another similar page of lower ranked results. Results may be moved up or down from page to page.

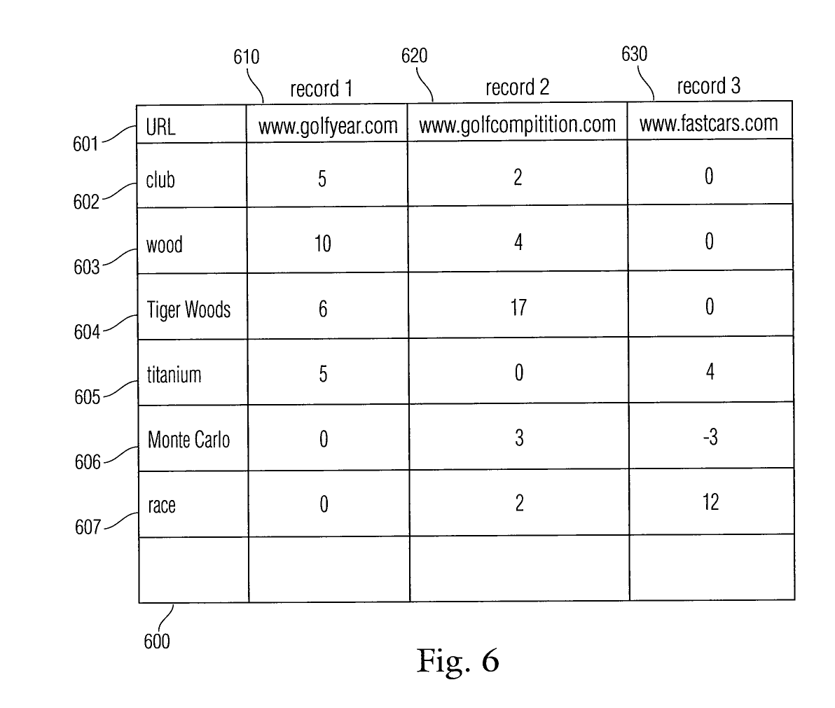

FIG. 6 is a diagram of a memory structure which is preferably utilized by the search services provider to perform the advanced ranking functions described above. It should be noted that this diagram shows the abstract organization of data and should not be taken to identify the physical organization of data on a storage device or even the logical organization of data in computer code, when the present invention is implemented. Persons of skill in the art would recognize that the general array structure of FIG. 6 may be converted into different, more complex structures in computer code for the purposes of efficiency, while retaining the functionality described below.

It should also be noted that the various websites and keywords listed in FIG. 6 are provided for exemplary purposes only and do not signify any endorsements of the present invention by websites, corporations, trademarks or persons which may be named therein.

The structure of FIG. 6 is a table 600 comprising a plurality of records 610, 620, 630, wherein each record is associated with a webpage which has previously appeared as a search result and has also obtained some ranking specific information (i.e. a user has moved it up or down n the rankings or a user has clicked on it). A URL field 601 holds the URL of the webpage to which each record corresponds.

Fields 602 through 607 are each associated with a specific keyword or a combination of keywords which may have been searched for by a user before. The fields of the records corresponding to these keywords signify the score the webpage of the record has achieved for that particular keyword as a result of user actions (i.e., moving a search result associated with that webpage up or down, or clicking on the search result). As discussed above, moving up or clicking may result in a different amount of points, and moving down may result in negative points.

Thus, for example, the www.golfgear.com webpage may have a rating 5 for the keyword “titanium” because some golf clubs are made of that metal. Similarly, www.fastcars.com may have a rating 4 for titanium, because some high performance engines include titanium parts. Meanwhile, the cite www.golfcompetition.com may have a 0 rating for titanium because the make up of golf clubs is usually not an issue during golf competition. Thus, the various webpages have separate scores for each keyword. In the preferred embodiment, a webpage's advancement in one keyword will not improve its score when the search is based on a different keyword.

When various users perform additional searches and use the move button and click on various search results the scores of the various keyword fields are modified accordingly. New columns may be added to the table if new webpages appear as search results and are clicked on or manipulated by the move buttons. New rows may be added as new search terms are used to perform searches. Thus, in practice, table 600 may have millions of rows and columns.

Note that the webpages listed in row 601 are webpages corresponding to search results. They are not necessarily participating websites or verticals 302. Thus, they need not have the search box 202 installed on them. In other words, one may only use a participating website or vertical to perform a search, but once the search is performed, the results need not be participating websites or verticals. Of course it is possible that participating websites and verticals, or webpages belonging to them may come up as search results for certain queries. In this case, they are preferably treated as ordinary webpages, and provided corresponding records in table 600 as needed.

It should be noted that some of the inventive features described thus far may be grouped in two major aspects: providing context for searching, and ranking results based on user actions. Both of these aspects offer significant advantages over currently existing searching methods. Embodiments of the present invention may feature either of these aspects independently without featuring the other. However, the preferred embodiments feature both aspects.

A single table 600 may be sufficient for embodiments of the present invention which only feature the ranking based on user input concept. However, if the context based searching concept is to be featured as well, table 600 may not be quite sufficient. That is because in the preferred embodiment keywords alone are not sufficient to define a search in context based searching. The context of the search must also be accounted for.

In one embodiment, the context of the search is accounted for by adding to each key word 602-607 the one or more context words of each participating website or vertical. For example if websites www.golf.com and www.autoworld.com are both participating, and have context words “golf”, and “automobile” respectively, keyword fields 602-607 of table 600 will be have the word “golf” and “automobile” added to them depending on which participating website these keywords were searched for. If any of the keywords were searched for on both participating websites, multiple key word fields may be used with each website's context word appended to one of the fields. Thus, the keyword field Monte Carlo would turn into two keyword fields—“golf Monte Carlo” and “automobile Monte Carlo.”

In the preferred embodiment the keyword fields are not appended, but rather multiple tables are used. Thus, each participating website or vertical will have a corresponding table similar to table 600, but probably having different records, keyword fields, and values in it. This is due to the fact that the search terms, the search results and the user actions upon those search results would probably differ for the different participating websites.

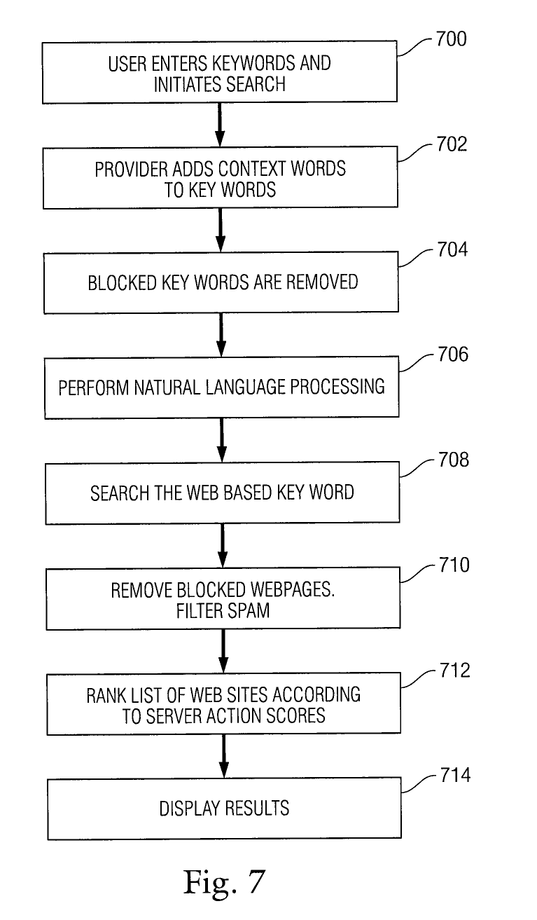

FIG. 7 is a flowchart showing how a search is performed according to a preferred embodiment of the invention. A user is browsing a participating website or vertical 302 and he/she decides he needs some additional information. The user notices a search box at the website or vertical and enters one or more keywords or search terms in step 700. The user then initiates the search by either pressing a key on a keyboard (such as the ‘Enter’ key) or clicking on a specified area of the search box. Alternatively, instead of entering any keywords, the user may click on one of the suggested search terms provided at the search box.

Subsequently, the user's browser, in accordance with the search box code of the participating website sends a search request along with the entered keywords or clicked on suggested search term (referred to as keywords hereafter) to the search services provider 303. Since this step reflects ordinary browser operation it is not explicitly shown in FIG. 7.

At step 702, the provider receives the search request and combines the received keywords with the one or more context words associated with the participating website. Preferably the provider includes a record of all registered participating websites and/or verticals as well as their associated context words. The context words are defined by at the scanning step 406 during registration of a participating website/vertical, and may be updated periodically thereafter through subsequent periodic scanning.

At step 704, any blocked keywords are removed. Administrators of participating websites or verticals may choose to block various keywords (see description of step 402 of FIG. 4). Preferably, the search services provider stores a list for the blocked keywords and/or webpages for each participating website. At step 704, the search services provider checks the saved list of blocked keywords against the current keywords obtained in steps 700 and 702 and removes any blocked keywords. If no keywords are left, the search services provider cancels the search and issues a webpage with an error message instead of a results page.

At step 706, natural language processing of the combined keywords and context words is performed. Since the context words are appended to the keywords automatically they may result in a phrase which may be meaningless in natural language. For example if the entered keyword is “clubs” and the context word is “golf” then combining the two to form “clubs golf” would result in a meaningless phrase. However, combining them to form “golf clubs” would result in a meaningful phrase. A meaningful phrase is more likely to elicit useful information when used as a search query. Thus, at step 706, the combined keywords and context words are processed to form a meaningful phrase (if possible). This may be done by rearranging the order of the various words or even adding additional connecting prepositions.

There are existing services which will perform such natural language processing by comparing an input sequence of words with a large database of search queries which have been previously entered by persons at various search engines. Statistical analysis of the large number of queries (which are presumably in natural language, as they were entered in by human beings) allows these services to make modifications to the input sequence of words to convert them into natural language. One such existing service is available at www.wordtracker.com.

At step 708, the search services provider performs a search of the web based on the natural language processed keywords. At this point, a conventional search is performed. This may be done by any known conventional method of searching the web.

In the preferred embodiment, the search of step 708 is performed by utilizing outside vendors of search services. These may include, for example, Google, Yahoo, and Ask.com each of which presently offers wholesale search services to other companies. For example, for a small fee, the search services provider 303 may send the combined and natural language processed keywords to Google, and Google will perform a search based on these keywords and send a list of results (sans advertisements) ranked according to Google's algorithm back to the search services provider 303.

To ensure high quality search results, the preferred embodiment uses multiple such third party search providers—preferably Google, Yahoo and Ask.com. Once the results of each provider are received, they are all merged into a single list of results. Redundant results are eliminated and the rest of the results are ranked according to the relative rankings given by each search provider. Usually, most search providers indicate rankings based on a percentage scale score; these scores are used to determine the merged results' rankings.

At step 710, webpages which have been indicated as blocked by the administrator of the participating website or vertical where the current search was initiated are removed. Furthermore, spam filtering is performed. Webpages of the results are checked whether they are spam—i.e. whether they are webpages which do not have much useful information and are not really related to the searched for terms, but are only created to artificially get a high search ranking so that they can display adds. Sometimes, spam webpages are even more nefarious—instead of displaying ads they attempt to install malicious software on the user's computer.

Spam filtering may be performed according to several known methods. For example, the URL can be checked. Unusual and overly long URLs may be indicators of a spam webpage. Also the webpage may be scanned and its most often appearing keywords may be compared to its title and metadata. If there is not even a partial match, the webpage is probably spam.

At step 712 the list of websites is re-ranked based on the scores derived from previous user actions (i.e., moving and clicking) discussed above in the context of FIG. 6. More specifically, in the preferred embodiment, the search services provider retrieves a table 600 which is associated with the participating website or vertical where the search request was initiated. The keywords of the present search (sans the context words) are checked against the key words of fields 602-607. If any matches are found, each of the webpages remaining in the list of search results after step 710 is checked against the records of webpages 610-630. If a match is found, a user input based score is obtained from the table for each matching webpage of the list of search results. Webpages for which there is no match are given a score of ‘0’. Then the webpages are re-ranked according to their user input based scores. The original ranking (i.e., the one contributed by the third party providers, such as Google, Yahoo, Ask.com, etc.) is preserved only in the case where two webpages of the search results have the same score. In this way the input of previous users is usually the major factor in the final ranking of the search results.

At step 714, the search services provider constructs a webpage similar to page 501 of FIG. 5 which includes the search results. This page is sent back to the user's browser. If the search results are too many, the user may be given the option of navigating among multiple pages of results.

Sponsored results may be obtained by a method similar to the one described in FIG. 7. Some notable differences may be that at step 708 instead of searching the web, a list of sponsored links is requested by sending the keywords to a sponsored links broker, such as, for example Adwords. Also, spam filtering is preferably not performed on sponsored results—the fact that the links are sponsored tends to indicate that they are not spam. Furthermore, where the sponsored links broker requires that the links be presented in a particular order, the re-ranking step 712 is not performed.

In some embodiments of the present invention, the participating website, or vertical owner or administrator may be remunerated for placing a search box in his/her website. The owner of the search services provider may receive revenue from a sponsored links broker for displaying the various sponsored results and in turn send some of the revenue to the owners of the various participating websites and/or verticals. If that is the case, the search services provider must store accounting data for each participating website, and/or vertical. The accounting data may show, for example, how many sponsored results were displayed as a result of searches initiated from each participating website or vertical, how many clicks on sponsored results were generated for each website/vertical, which sponsored results were clicked on, etc.

Two of the significant features of the present invention are context based searching and user input based ranking of results. As discussed above, these features may be combined or used separately and independently in the different embodiments of the present invention.

The present description centered on a specific implementation of the context based searching feature. In this implementation the context was defined by automatically determining one or more context words and adding these context words to a search string. There are other possible ways to perform context based searching which are also included in the present invention. For example, there have been many attempts to sort the information of the Web into categories. The context of the context based search may be may be provided by limiting the search to one of these categories (preferably the category which holds the participating website from which the search was initiated).

Alternatively, the search may be limited according to the interconnecting links between websites. Thus, for example a search initiated from a particular participating website may encompass only other websites which are connected to it directly or indirectly by no more than a predefined number of hyperlinks. Thus, a user will be able to search all websites within an n-th degree of separation from the participating website (n being the predefined number of hyperlinks).

Generally the above embodiments are described in the context of the World Wide Web (the Web) and the Internet. A person of skill in the art would recognize that the present invention is not limited to the Internet or the Web but may be adapted to any large and dispersed storage of information. Furthermore, the present invention is not limited to the current hypertext and webpage based implementation of the Web and the Internet, and may be adapted to any future implementation.

One skilled in the art may devise many alternative configurations for the systems and methods disclosed herein. For example, the visual structure of the webpages discussed herein may be modified, and the various steps of the methods discussed herein may be modified, or their order changed. Therefore, it should be understood that the present invention may be embodied in many other specific forms without departing from the spirit or scope of the invention and that the present examples are to be considered as illustrative and not restrictive. Thus, the invention is not to be limited to the details given herein. It may encompass any embodiments within the scope of the claims below.

APPENDIX A
Example of search box code

<!-- Vortal Code Begins Here -->
<table width=“100%” border=“0” cellspacing=“0” cellpadding=“0”>

<tr>

<td><xstyle type= ‘text/css’>

.vortal_box
{

background-color:transparent;
border:0px solid;
border-color:transparent;
padding-left: 8px;
padding-right: 5px;
padding-bottom: 6px;
padding-top: 1px;

}
.vortal_bar
{background-color:transparent;}
.vortal_textfield
{

font-family: Arial, Helvetica, sans-serif;
font-size: 10px;
color:666666;
height: 16px;
padding-left: 2px;width: 100%;
border: 1px solid;
border-color:B9B9B9

}
.vortal_largelinks
{

font-family: ‘Trebuchet MS’, Arial, Verdana;
font-size: 16px;
text-decoration: none;
font-weight: bold;
color:0099CC;

}
.vortal_smalllinks
{

font-family: ‘Trebuchet MS’, Arial, Verdana;
font-size: 10px;
color:0099FF;
text-decoration: none;

}
.vortal_linkcolor
{
color:0099ff;
}
</style>
<div class=“vortal_bar”>
<form name=“form1” method=“get”
action=“http://secure.searchvortal.com/results .php”
style=“margin: 0px”>
<input type=“hidden” name=“vid” value=“10”>

<table width=“100%” border=“0”

cellspacing=“0” cellpadding=“0”>

<tr>

<td height=“1” colspan=“3”><img

src=“http://secure.searchvortal.com/images/spacer.gif” width=“5”
height=“5”></td>

</tr>
<tr>

<td width=“1”><img

src=“http://secure.searchvortal.com/images/spacer.gif” width=“5”
height=“5”></td>

<td><table width=“100%” border=“0”

cellpadding=“0” cellspacing=“0”>

<tr>

<td nowrap><input name=“search”

type=“text” class=“vortal_textfield”></td>

<td width=“1”><img

src=“http://secure.searchvortal.com/images/spacer.gif” width=“5”
height=“6”></td>

<td width=“56” valign=“top”><input

name=“Submit2” type=“image” value=“Submit”
src=“http://secure.searchvortal.com/images/search_button.jpg”
width=“56” height=“16”></td>

<td width=“21”><a

href=“http://www.searchvortals.com”><img
src=“http://secure.searchvortal.com/images/get_your_vortal.gif”
width=“21” height=“16” border=“0”></a></td>

</tr>

</table></td>
<td width=“1”><img

src=“http://secure.searchvortal.com/images/spacer.gif” width=“5”
height=“5”></td>

</tr>
<tr>

<td height=“1” colspan=“3”><img

src=“http://secure.searchvortal.com/images/spacer.gif” width=“5”
height=“5”></td>

</tr>

</table>
</form>

</div>
<div class=“vortal_box”>
<div class=“vortal_largelinks”>

<div align=‘center’>
<a

href=“http://secure.searchvortal.com/results.php?vid=10&search=r
oller+massage” class=“vortal_linkcolor”>roller massage</a>,

<a

href=“http://secure.searchvortal.com/results.php?vid=10&search=m
assage+chairs” class=“vortal_linkcolor”>massage chairs</a>,

<a

href=“http://secure.searchvortal.com/results.php?vid=10&search=s
hiatsu+massage” class=“vortal_linkcolor”>shiatsu massage</a>,

<a

href=“http://secure.searchvortal.com/results.php?vid=10&search=p
opular+massage” class=“vortal_linkcolor”>popular massage</a>,

<a

href=“http://secure.searchvortal.com/results.php?vid=10&search=a
cupunture” class=“vortal_linkcolor”>acupunture</a>,

<a

href=“http://secure.searchvortal.com/results.php?vid=10&search=m
assage” class=“vortal_linkcolor”>massage</a>,

<a

href=“http://secure.searchvortal.com/results.php?vid=10&search=m
assage+therapy” class=“vortal_linkcolor”>massage therapy</a>,

<a

href=“http://secure.searchvortal.com/results.php?vid=10&search=f
eet+massage” class=“vortal_linkcolor”>feet massage</a>,

</div>

</div>
<div class=‘vortal_smalllinks’>

<div align=‘center’>
<a

href=“http://secure.searchvortal.com/results.php?vid=10&search=t
herapeutic+body+healing” class =“vortal_linkcolor”>therapeutic
body healing</a>,

<a

href=“http://secure.searchvortal.com/results.php?vid=10&search=m
ind+therapy” class=“vortal_linkcolor”>mind therapy</a>

</div>

</div></div></td>

</tr>

</table>
<!-- Vortal Code Ends Here --></td>

We claim:

1. A method for presenting search results comprising:
storing ranking data in a data structure, said ranking data being based on input from a plurality of users, the input relating to the relevance of search results for a search term;
receiving a search request from a user, the search request including the search term;
performing a search to obtain a plurality of results;
retrieving the stored ranking data; and
reordering the results according to the stored ranking data.

2. The method of claim 1, further comprising:
displaying the reordered search results to a user;
allowing the user to provide new input; and
modifying the stored ranking data in accordance with the user's new input.

3. The method of claim 2, wherein the stored ranking data includes a plurality of data items, each data item being associated with a specific search term.

4. The method of claim 3, wherein a search term is a phrase of two or more words.

5. The method of claim 3, wherein the search request is issued by the user at a first webpage, and the ranking data includes a plurality of sets of data items wherein each set of data items is associated with a webpage of a group of participating webpages, the first webpage being comprised by the group of participating webpages.

6. The method of claim 2, wherein the user provides new input by selecting one of the search results.

7. The method of claim 2, further including the step of displaying a “move up” interface for each search result and wherein the user provides new input by invoking the “move up” interface for a particular search result.

8. The method of claim 7 further including the step of modifying the display of reordered search results by moving the particular search result up in the order of search results.

9. The method of claim 2, further including the step of displaying a “move down” interface for each search result and wherein the user provides new input by invoking the “move down” interface for a particular search result.

10. The method of claim 9 further including the step of modifying the display of reordered search results by moving the particular search result down in the order of search results.

11. A method for performing a context based search, comprising:
adding a search interface to a visualizable information unit;
automatically deriving a context description from the visualizable information unit, the context description being related to the information within the visualizable information unit;
allowing a user to request a search using the search interface by sending one or more search terms to the search interface; and
performing a search based on the one or more search terms and the context description.

12. The method of claim 11, wherein the visualizable information unit is a webpage.

13. The method of claim 11 wherein, the automatically deriving a context description step further comprises the steps of:
scanning the visualizable information unit;
selecting one or more context terms which comprise the most often repeated words of the visualizable information unit.

14. The method of claim 13, wherein the automatically deriving the context description step further includes:
removing one or more commonly used words from the selected context terms.

15. The method of claim 13, wherein performing a search further comprises combining the one or more search terms with the one or more context terms to form a plurality of combined terms and performing a search based on the plurality of combined terms.

16. The method of claim 15, further including the step of performing natural language processing on the plurality of combined terms in order to modify the plurality of combined terms and place them in a format consistent with natural language.

17. The method of claim 11, further including the step of adding one or more suggested search terms to the search interface.

18. The method of claim 17, wherein the allowing the user to request a search step further comprises allowing the user to select one of the suggested search terms.

19. The method of claim 18, wherein the adding one or more suggested search terms further includes requesting an administrator of the visualizable information unit to select the suggested search terms.

20. The method of claim 18, wherein the adding one or more suggested search terms further includes
scanning the visualizable information unit; and
selecting one or more of the most often repeated words of the visualizable information unit as suggested search terms.

21. The method of claim 20, further including ranking the suggested search terms, and displaying the suggested search terms in two or more different styles depending on their ranking.

22. The method of claim 11 further including the steps of:
allowing an administrator of the visualizable information unit to select one or more blocked search terms; and
removing any blocked search terms present in the one or more search terms communicated by the user.

23. The method of claim 11, further including the steps of
allowing an administrator for the visualizable information unit to select one or more blocked results;
obtaining one or more search results based on the performed search; and
removing any blocked results present in the one or more search results.

24. A method for performing a context based search, comprising:
adding a search interface to a visualizable information unit;
storing in a data structure a plurality of sets of ranking data based on input from a plurality of users about the relevance of search results, each of the sets of ranking data being associated with a specific search term of a plurality of search terms;
automatically deriving a context description from the visualizable information unit, the context description being related to the information within the visualizable information unit;
allowing a user to request a search from the search interface by communicating a search term to the search interface;
performing a search based on the search term and the context description;
retrieving a set of ranking data associated with the search term entered by the user from the data structure; and
reordering the results according to the set of ranking data.

25. The method of claim 24, wherein the visualizable information unit is a webpage.

26. The method of claim 24, further comprising:
displaying the reordered search results to a user;
allowing the user to provide new input; and
modifying the set of ranking data in accordance with the user's new input.

27. The method of claim 24, wherein the plurality of sets of ranking data are uniquely associated with the visualizable information unit.

28. A system for presenting search results comprising a search services provider, the search services provider including a processor and a memory, the memory further comprising:
a data structure comprising ranking data based on user input about the relevance of search results for a search term; and
a plurality of computer instructions, the computer instructions being operative to cause the processor to:
receive a search request from a user, the search request including the search term;
performing a search based on the search term to obtain a plurality of results;
retrieve the stored ranking data; and
reorder the results according to the stored ranking data.

29. The system of claim 28, further including additional computer instructions operative to cause the processor to:
display the reordered search results to a user;
allow the user to provide new input; and
modify the stored ranking data in accordance with the user's new input.

30. The system of claim 29, wherein the stored ranking data includes a plurality of data items, each data item being associated with a specific search term.

31. The system of claim 30, wherein a search term is a phrase of two or more words.

32. The system of claim 30, wherein the search request is issued by the user at a first webpage, and the ranking data includes a plurality of sets of data items wherein each set of data items is associated with a webpage of a group of participating webpages, the first webpage being comprised by the group of participating webpages.

33. The system of claim 29, wherein the user provides new input by selecting one of the search results.

34. The system of claim 29, further including the step of displaying a “move up” interface for each search result and wherein the user provides new input by invoking the “move up” interface for a particular search result.

35. The system of claim 34 further including additional computer instructions operative to cause the processor to modify the display of reordered search results by moving the particular search result up in the order of search results.

36. The system of claim 29, further including additional computer instructions operative to cause the processor to display a “move down” interface for each search result and wherein the user provides new input by invoking the “move down” interface for a particular search result.

37. The method of claim 36 further including additional computer instructions operative to cause the processor to modify the display of reordered search results by moving the particular search result down in the order of search results.

38. A system for performing a context based search, comprising a search services provider, the search services provider comprising a processor and a memory, the memory comprising instruction which are operative to cause the processor to:
add a search interface to a visualizable information unit;
automatically derive a context description from the visualizable information unit, the context description being related to the information within the visualizable information unit;
allow a user to request a search from the search interface by communicating one or more search terms to the search interface; and
perform a search based on the one or more search terms and the context description.

39. The system of claim 38, wherein the visualizable information unit is a webpage.

40. The system of claim 38 further including additional computer instructions operative to cause the processor to:
scan the visualizable information unit;
select one or more context terms which comprise the most often repeated words of the visualizable information unit.

41. The method of claim 40, wherein the automatically deriving the context description step further includes:
removing one or more commonly used words from the selected context terms.

42. The system of claim 40, further including additional computer instructions operative to cause the processor to combine the one or more search terms with the one or more context terms to form a plurality of combined terms and perform a search based on the plurality of combined terms.

43. The system of claim 42, further including additional computer instructions operative to cause the processor to perform natural language processing on the plurality of combined terms in order to modify the plurality of combined terms and place them in a format consistent with natural language.

44. The system of claim 38, further including additional computer instructions operative to cause the processor to add one or more suggested search terms to the search interface.

45. The system of claim 44, further including additional computer instructions operative to cause the processor to allow the user to select one of the suggested search terms as part of allowing the user to request a search.

46. The system of claim 45, further including additional computer instructions operative to cause the processor to allow an administrator of the visualizable information unit to select the suggested search terms.

47. The system of claim 45, further including additional computer instructions operative to cause the processor to:
scan the visualizable information unit; and
select one or more of the most often repeated words of the visualizable information unit as suggested search terms.

48. The method of claim 47, further including additional computer instructions operative to cause the processor to rank the suggested search terms, and display the suggested search terms in two or more different styles depending on their ranking.

49. The system of claim 38 further including additional computer instructions operative to cause the processor to:
allow an administrator of the visualizable information unit to select one or more blocked search terms;
store the blocked search terms in the memory; and
remove any blocked search terms present in the one or more search terms communicated by the user.

50. The method of claim 38, further including additional computer instructions operative to cause the processor to:
allow an administrator for the visualizable information unit to select one or more blocked results;
store the blocked results in the memory;
obtain one or more search results based on the performed search; and
remove any blocked results present in the one or more search results.

51. A system for presenting search results comprising a search services provider, the search services provider including a processor and a memory, the memory further comprising:
a data structure comprising a plurality of sets of ranking data based on input of plurality of users about the relevance of search results, each of the sets of ranking data being associated with a specific search term of a plurality of search terms; and
a plurality of computer instructions, the computer instructions being operative to cause the processor to:
add a search interface to a visualizable information unit;
automatically derive a context description from the visualizable information unit, the context description being related to the information within the visualizable information unit;
allow a user to request a search from the search interface by communicating a search term to the search interface;
perform a search based on the search term and the context description;
retrieve a set of ranking data associated with the search term entered by the user from the data structure; and
reorder the results according to the set of ranking data.

52. The system of claim 51, wherein the visualizable information unit is a webpage.

53. The system of claim 52, further including additional computer instructions operative to cause the processor to:
display the reordered search results to a user;
allow the user to provide new input; and
modify the set of ranking data in accordance with the user's new input.

54. The system of claim 51, wherein the plurality of sets of ranking data are uniquely associated with the visualizable information unit.
